(19) United States
(12) Patent Application Publication
(10) Pub. No.: US 2022/0406148 A1
(43) Pub. Date: Dec. 22, 2022

(54) GAMING DEVICES AND METHODS FOR POKER GAME WITH HAND IMPROVEMENT FEATURE

(71) Applicant: KING SHOW GAMES, INC., Minnetonka, MN (US)

(72) Inventor: Jacob LAMB, Maple Grove, MN (US)

(21) Appl. No.: 17/842,779

(22) Filed: Jun. 16, 2022

Related U.S. Application Data
(60) Provisional application No. 63/211,376, filed on Jun. 16, 2021.

(51) Int. Cl. G07F 17/32

(52) U.S. Cl. CPC G07F 17/3293; G07F 17/3265; G07F 17/3213; G07F 17/3209

(57) ABSTRACT

Embodiments of the present invention set forth systems, apparatuses and methods for implementing poker games with a hand improvement feature on gaming devices. Accordingly, a gaming device can be configured to operate a poker game by randomly determining a poker hand to deal on a game grid of the display, determining if the dealt poker hand satisfies an upgrade criterion, and implementing an upgrade feature to improve the dealt poker hand when the dealt poker hand satisfies the upgrade criterion. Thereafter, the improved poker hand, or just the dealt poker hand if it did not satisfy the upgrade criterion, may be played.

### RELATED APPLICATIONS

This application claims the benefit of Provisional Patent Application No. 63/211,376, filed on Jun. 16, 2021, to which priority is claimed pursuant to 35 U.S.C. § 119(e) and which is incorporated herein by reference in its entirety.

### FIELD OF THE INVENTION

This disclosure relates generally to games, and more particularly to systems, apparatuses and methods for implementing poker games with a hand improvement feature on gaming devices.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate implementing poker games with a hand improvement feature on gaming devices. In one embodiment, a gaming device having a display, user interface, wager input device, memory and processor is operable to play a video poker gaming event upon receipt of a wager and game initiation signal. The processor of the gaming device is configured to operate the video poker gaming event including randomly determining a poker hand to deal on a game grid of the display. The processor is further configured to determine if the dealt poker hand satisfies an upgrade criterion, and implement an upgrade feature to improve the dealt poker hand when the dealt poker hand satisfies the upgrade criterion. Thereafter, the improved poker hand, or just the dealt poker hand if it did not satisfy the upgrade criterion, may be played.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a gaming machine according to embodiments of the invention.

FIG. 2 is a block diagram illustrating a computing arrangement according to embodiments of the invention

FIGS. 3A and 3B are detail diagrams of a gaming device display showing a game progression according to embodiments of the invention.

FIG. 4 is a block diagram of a representative gaming apparatus for providing a hand improvement feature according to embodiments of the invention.

FIGS. 5A and 5B are detail diagrams of a gaming device display showing a game progression according to embodiments of the invention.

FIGS. 6A and 6B are detail diagrams of a gaming device display showing a game progression according to embodiments of the invention.

FIGS. 7A and 7B are detail diagrams of a gaming device display showing a game progression according to embodiments of the invention.

FIGS. 8A and 8B are detail diagrams of a gaming device display showing a game progression according to embodiments of the invention.

FIGS. 9A, 9B, 9C, and 9D are detail diagrams of a gaming device display showing a game progression according to embodiments of the invention.

FIGS. 10A, 10B, 10C, and 10D are detail diagrams of a gaming device display showing a game progression according to embodiments of the invention.

FIGS. 11A and 11B are detail diagrams of a gaming device display showing a game progression according to embodiments of the invention.

FIGS. 12A and 12B are detail diagrams of a gaming device display showing a game progression according to embodiments of the invention.

FIGS. 13A and 13B are detail diagrams of a gaming device display showing a game progression according to embodiments of the invention.

FIGS. 14A and 14B are detail diagrams of a gaming device display showing a game progression according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for implementing poker games with a hand improvement feature in gaming activities on gaming devices. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. video poker game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that utilizes operations of implementing a hand improvement feature for a poker game on gaming devices. In one embodiment, a gaming device having a display, user interface, wager input device, memory and processor is operable to play a video poker gaming event upon receipt of a wager and game initiation signal. The processor of the gaming device is configured to operate the video poker gaming event including randomly determining a poker hand to deal on a game grid of the display. The processor is further configured to determine if the dealt poker hand satisfies an upgrade criterion, and implement an upgrade feature to improve the dealt poker hand when the dealt poker hand satisfies the upgrade criterion. Thereafter, the improved poker hand, or just the dealt poker hand if it did not satisfy the upgrade criterion, may be played.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve video poker machine examples of this concept, other embodiments include application of these inventive techniques in other types of poker games, slot games, or other games of chance. Some of these other types of embodiments will be discussed below as variations to the examples illustrated. However, many other types of games can implement similar techniques and fall within the scope of this inventive concept.

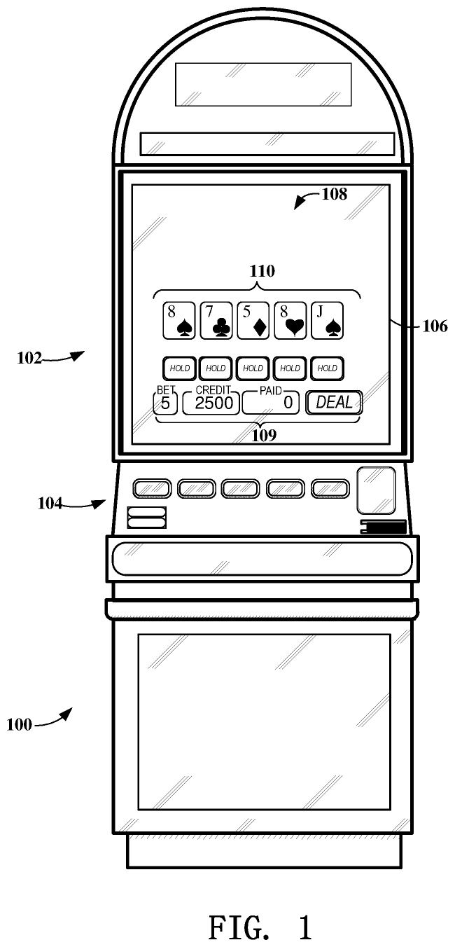

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity. In video poker embodiments, for example, the user interface 104 may include five physical buttons that correspond to displayed card positions and allow a player to hold (or un-hold) particular cards in a draw poker hand. The user interface 104 may also include a physical “Deal/Draw” button that allows a player to initiate a new game by having cards dealt to the card positions or draw replacement cards after having the opportunity to hold any of the dealt cards. In other poker games, keno games, slot games, or other games of chance different button panels or configurations may be used.

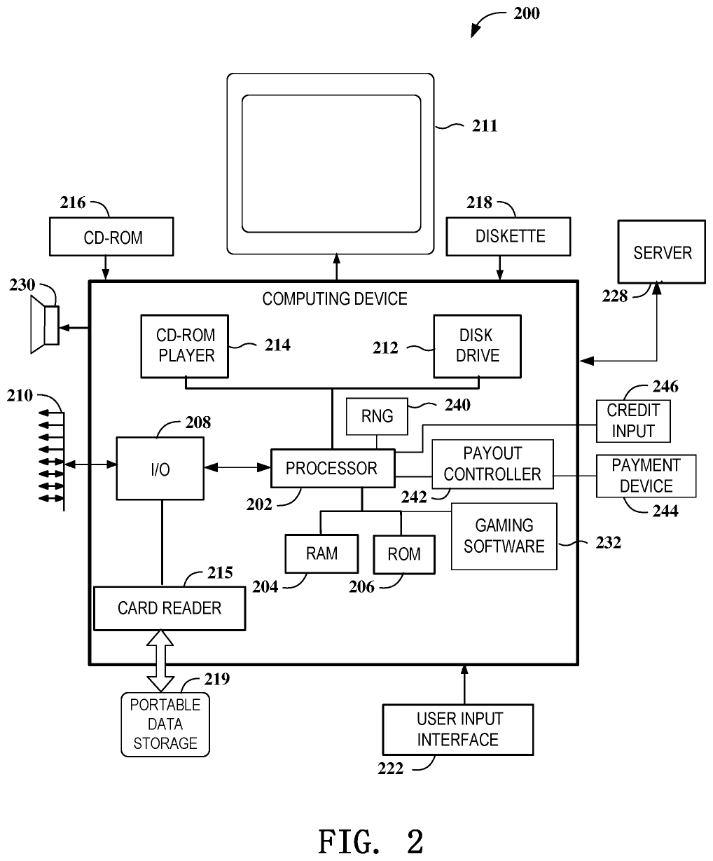

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player loyalty information to identify a user or player of the gaming device. This mechanism may be card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some of the example embodiments illustrated herein, the primary gaming portion 108 may display a grid (or equivalent arrangement) of playing cards 110 forming a hand. Here, the grid includes a row of five playing cards 110 forming a video poker hand, which represents a portion of a game play event. For example, if the game play event is a video draw poker game, the gaming device 100 may deal five cards, allow the user to select which cards to hold, deal replacements for the cards not held, and determine a payout based on the final cards in the hand. The illustration and description of five-card-draw poker is for purposes of example and not of limitation; the present invention may be applicable to numerous other card games, such as stud poker or hold 'em poker, as well as other types of gaming activities and apparatuses, such as slot machines, dice, coins, etc.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual cards for holding prior to draw of new cards. The game display 106 of the display area 102 may include other features that are not shown, such as paytables, navigation controls, etc.

In other example embodiments, the primary gaming portion 108 may display a grid (or equivalent arrangement) of game elements or game element positions (also referred to as “reel stop positions” herein). Although not shown in FIG. 1, the grid may include three rows and five columns of game elements, which may form a game outcome of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

Although FIG. 1 illustrates a particular implementation of some of the embodiments of this invention in a casino or electronic gaming machine (“EGM”), one or more devices may be programmed to play various embodiments of the invention. The present invention may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the invention is illustrated in FIG. 2.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 200 of FIG. 2 is an example computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions in accordance with the present invention typically includes a central processor (CPU) 202 coupled to random access memory (RAM) 204 and some variation of read-only memory (ROM) 206.

The ROM 206 may also represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like. The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to the display 211, which represents a display on which the gaming activities in accordance with the invention are presented. The display 211 represents the “presentation” of the game information in accordance with the invention, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. The present invention is operable using any known RNG, and may be integrally programmed as part of the processor 202 operation, or alternatively may be a separate RNG controller 240. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout device 244 may also be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described hereinabove. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 232 may include instructions to provide other functionality as known in the art or as described and shown herein.

As indicated above, embodiments of the invention are directed to gaming devices and methods of operating gaming devices to play gaming events where an enhanced game starting process using a hand improvement feature is provided to increase the entertainment, and hence the desirability, of the gaming devices. According to some embodiments, a video poker gaming event may be implemented on the gaming device where a dealt poker hand (and in some draw poker embodiments, both the dealt poker hand and final draw poker hand) are evaluated to determine if they meet an upgrade criterion. Here, the upgrade criterion may be used so that particular poker hands are improved and provide an improved chance of resulting in a desirable (for example, higher paying and/or more entertaining) poker hand when evaluated for awards. This hand improvement feature may be particularly useful for poker hands where there is a “correct” or “best way” to play for optimum strategy and payback, but that eliminates certain high paying outcomes when used. For example, when a player is dealt two pairs of cards in an initial dealt hand for a draw poker game, such as 5s Kd 8h 5c 8d, the optimum strategy is generally to hold the pair of fives and the pair of eights, thereby ensuring a winning outcome. However, by playing this optimum strategy, the player eliminates the possibility of getting a Four of a Kind on the draw, which is generally associated with a much higher pay then the pay for two pairs (or even a Full House if an additional one of the cards of the same ranks as the two pairs is drawn in the one non-held card position). Of course, the player may choose to hold only one of the pairs to keep open the possibility of receiving a Four of a Kind, but mathematically speaking over time this strategy will return much less than holding both pairs and the single low pair does not generally pay any award and the chance of drawing two more cards of the same rank as the held pair happens relatively infrequently.

In other embodiments, the hand improvement feature can take an otherwise unremarkable (e.g., non-winning) dealt (or final drawn) poker hand and upgrade it to a hand with a guaranteed chance of winning, a much higher chance of winning, or a hand that is otherwise enhanced or modified. In one example embodiment, a dealt poker hand that has a pair and an Ace will be upgraded by replacing the Ace with a card of the same rank as the pair to ensure the poker hand will have at least a 3 of a Kind. This is especially valuable when the pair is a low pair (pairs of 2 through 10 cards that are not usually associated with an award in most video poker paytables).

Thus, in some embodiments, the upgrade criterion is related to the cards in the poker hand itself. In these embodiments, the processor of the gaming machine may evaluate the combination of cards dealt (and/or as a final poker hand in some embodiments) to determine if at least a portion of that combination of cards matches an entry in a predefined table of card combinations to upgrade. Here, for example, if the upgrade criterion is based on the dealt poker hand having two pairs of cards, the processor may evaluate the dealt poker hand to determine if there are two pairs of cards in that combination of dealt cards. Each possible combination of two pairs may be listed in a lookup table, or the table may be truncated to lessen the number of entries while still covering all of the possible two pair combinations (such as by use of an * or other wild representation symbol). Alternatively, the processor may not use a lookup table for determining if a combination of cards satisfies an upgrade criterion, but may use an evaluation process using a rule compare algorithm or any other type of technique to ascertain whether the combination of cards satisfies the upgrade criterion.

In other embodiments, the upgrade criterion may not be related to rank and suit of the cards themselves, but to other types of indicia or occurrences in the poker game. For example, an upgrade subsymbol may be randomly associated with one or more cards in a virtual card deck. If a card with an upgrade subsymbol is dealt (and/or part of a final poker hand in some embodiments) the card itself with the upgrade sub symbol may be changed to upgrade the overall poker hand, or, in other embodiments, any of the other cards in the poker hand may be changed to upgrade the overall hand. That is, the upgrade subsymbol may only apply to the card on which it appears, or it may be a general indicator to upgrade the overall hand by changing any one of the cards in the hand to improve the poker hand. In other example embodiments, other types of the non-card related upgrade criteria may be used. For example, a random determination may be done before every hand to see if that hand will be upgraded or not. This may take the visual representation of an upgrade wheel or other bonus mechanic initiated at the beginning of the poker game to determine whether the poker hand will be upgraded. In yet other embodiments, two or more upgrade subsymbols (or other mechanics indicating multiple upgrades) may be received on a single hand. Here, multiple ones of the cards in the poker hand may be upgraded, or in other embodiments, only one card can be upgraded in a current hand, but any remaining upgrades awarded will be saved and used on the next poker game(s).

When a card is replaced due to the upgrading of the poker hand, the replaced card may be randomly returned to the virtual deck of cards to preserve conventional poker strategies in holding and drawing replacement cards. In other embodiments, the replaced cards from the upgrade may be removed from the virtual card deck for the remainder of the poker game. The card or cards being used to upgrade a poker hand may be taken out of the remaining cards in the virtual poker deck, which would simply play as if that card was originally dealt in the poker hand and thus not change any strategy in holding and drawing cards. In other embodiments, however, copies of the card used to upgrade the dealt poker hand may be used as the upgrade replacement card(s) while leaving the original card of the same rank and suit in the virtual card deck. In these types of embodiments, it would then be possible to draw a card that is already being held. This, in turn, may lead to the possibility of 5 of a Kind hands and other high-paying hands, as well as changing the probabilities of receiving certain other poker hands.

In some embodiments, the hand improvement feature may be further paired with a random modifier that may or may not be tied to the whether the poker hand is upgraded or not. That is, in some embodiments, a random multiplier may be applied the poker hands independently of whether a hand is upgraded. In other embodiments, a random hand modifier such as a multiplier may only be awarded when a hand is upgraded. This additional modifier feature may be used to enhance the excitement of the poker game and may also be a mechanism to ensure the game mathematics are consistent with known poker paytables. In some embodiments, the hand improvement feature may require a bonus bet or wager to be active, while in other embodiments, the poker paytable may be modified to account for the increase in winning poker hands due to the hand improvement feature. For example, in some embodiments that required a bonus bet to be eligible for the bonus feature, the bonus bet may be structured as a 5+1, 5+2,5+3, 5+4, 5+5, etc. where the bonus bet is the second number. Hence, in a 5+5 embodiment, the player would bet five credits on the poker hand and be paid according to a 5-credit paytable, while paying an additional 5 credits (10 credit total wager) to also be eligible for the bonus. As for determining how to upgrade a poker hand when a hand improvement feature is triggered, there are numerous methods and variations that can be used to upgrade and chance a poker hand. In the example discussed above where two pairs are upgraded to a 3 of a Kind, the upgrade process may randomly choose one of the pairs to upgrade to the 3 of a Kind, or the higher (or higher paying pair) may be upgraded. For example, in some poker paytables, 4 of Kinds for certain cards (such as Aces, or even 2's, 3's, and 4's) have a higher pay than other types of cards. Thus, pairs of these types of cards may be kept when they appear with another type of pair and converted to a 3 of Kind. In other embodiments, which pair is upgraded may be chosen at random. To make this example upgrade, one of the cards in the other pair may be replaced by a card of matching rank to create the 3 of Kind from the selected pair. In other embodiments, however, any of the other three cards outside the selected pair may be chosen as the card that is upgraded to create the 3 of Kind. Hence, a player may have their hand automatically upgraded to a Full House some of the time.

In other types of embodiments, the cards that are selected to be used in the upgrade may be selected based on predefined rules or what the best type of upgrade would be award-wise. For example, if a player received a hand with 8h 4h 6h Jh 8d, there may be several ways for this hand to be upgraded. Which upgrade is done may be based on predefined rules—such as a pair always receives a third card (here, for example, the 8's would be kept and random one of the other three cards would be replaced by a random one of 8s or 8c); or based on the highest paying upgrade (here, for example, all of the Heart cards 8h 4h 6h Jh would be kept and the 8d may be upgraded to a random Heart card to complete a flush hand). The particular rules and methods of selecting the cards to upgrade the hand have many possible variations that are contemplated for use with the hand improvement feature.

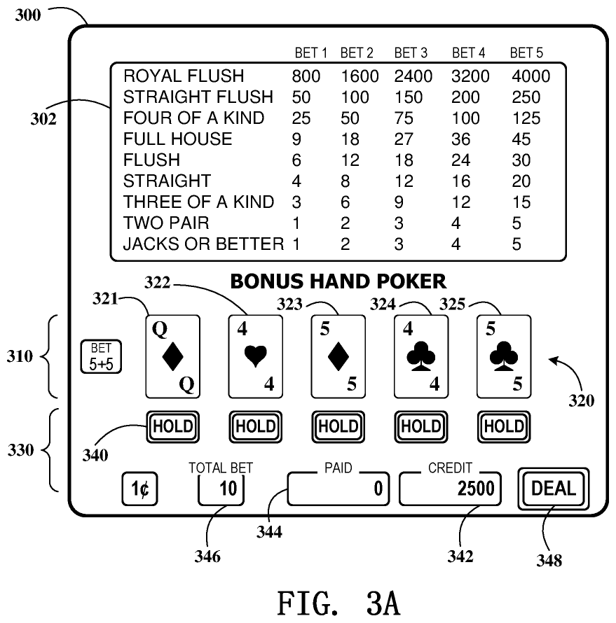

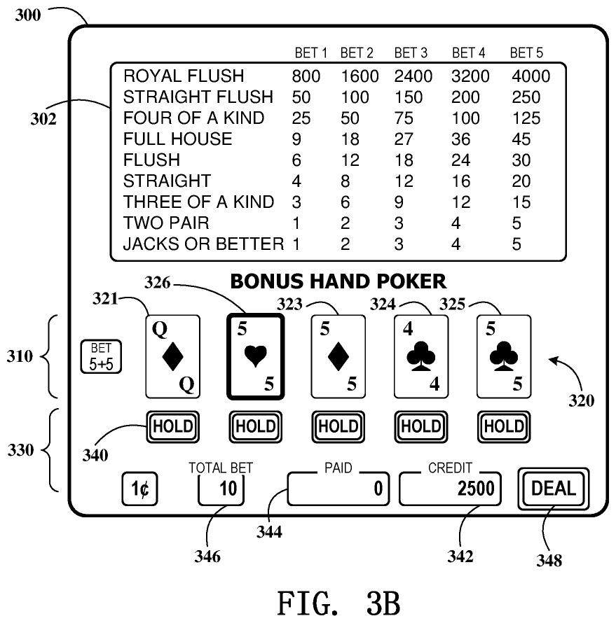

FIGS. 3A and 3B are detail diagrams of a gaming device display showing a game progression according to embodiments of the invention. Referring to FIGS. 3A and 3B, a gaming display device 300 may be configured to display a poker paytable 302 showing various possible awards associated with possible poker hands, a game play area 310 configured to display a grid of card positions 321-325 that allow for presentation of virtual playing cards making up one or more poker hands 320 as part of the poker game, and a player interface area 330 showing various buttons, meters, and/or information to allow the player to interact with the poker game on the gaming device. The player interface area 330 may, for example, include a plurality of Hold buttons 340 associated with each card in the poker hand 320 (if the poker game was a draw poker game), a Deal/Draw button 345 used to initiate a new poker game and indicate when the player has held the desired cards and is ready to draw new cards to any card positions where the previous cards were not held, a Credit meter 352 showing an available credit amount (that may be stored in the memory of the gaming device) for the player to use to place wagers on poker games, a Total Bet meter 354 showing an amount of a total wager or bet on a particular poker game or game event, and a Paid meter 356 showing a total award amount won based on a played poker game or game event. In other embodiments, additional or fewer buttons or meters may be present on the gaming device display 300. In addition, or alternatively, separate meters and/or physical buttons may be included in a player interface portion of the gaming device that is separate from the gaming device display 300.

In this embodiment shown in FIGS. 3A and 3B, when a player receives two pairs on the deal, one of the pairs will be selected to be upgraded to 3 of a Kind. Referring to FIG. 3A, an initial poker hand 320 is dealt to respective card positions 321-325 (the reference numbers 321-325 also referring to the cards dealt to the respective card positions) as follows: a Qd (Queen of Diamonds) 321, 4h (Four of Hearts) 322, 5d (Five of Diamonds) 323, 4c (Four of Clubs) 324, and 5c (Five of Clubs) 325. Here, this dealt poker hand 320 satisfies the upgrade criterion of having two pairs (i.e., the 4's and 5's). As shown in FIG. 3B, a processor determines (either randomly or based on a predefined rule such as being the larger rank of the pairs) that the 5's 323, 325 should be upgraded to a Three of Kind, and randomly determines one of the cards 322, 324 in the other pair to be replaced with one of the other 5's. Here, the 5h (Five of Hearts) 326 is selected to replace the 4h 322 in the poker hand. The player can then hold (likely the three 5's) and draw to complete the poker game. Although a draw poker game is shown in this embodiment, a similar process would work for a stud poker game, hold 'em poker game, or other type of poker or wagering game.

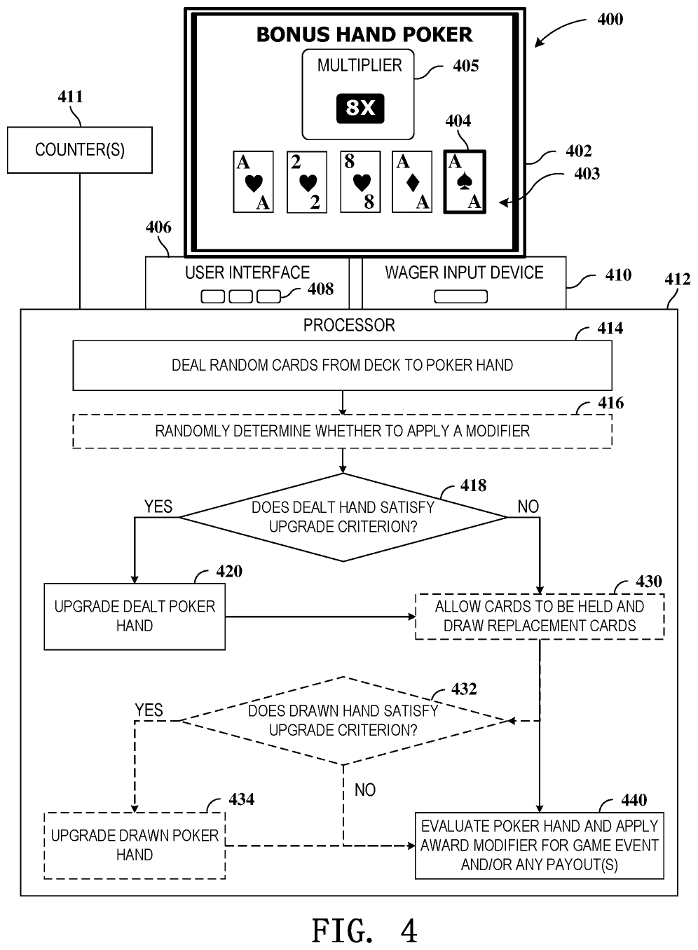

FIG. 4 is a block diagram of a representative gaming apparatus for providing a hand improvement feature according to embodiments of the invention. FIG. 4 and any other diagrams depicting a process flow represent operations in which a gaming device and/or gaming system can be operated according to representative embodiments. Although various processes may be depicted in a particular order, the order of these operations can be changed in other embodiments without deviating from the scope or spirit of this concept. Accordingly, the order of the processes shown is for illustrative purposes only and is not meant to be restrictive. Additional game processes may also be included between various processes even though they are not shown in these operational processes for purposes of clarity. The operations or processes may be performed by components in a single game device, such as by a game processor(s), or may be performed in part or whole by a remote server or processor(s) connected to the gaming device via a network. Each operation or process may be encoded in instructions that are stored in one or more memories, a computer-readable medium(s), or another type of storage device(s). The exemplary operations and methodologies depict representative embodiments of how game operations may be implemented. As discussed herein, many variations exist which may require additional, fewer, or different processes to complete.

Referring to FIG. 4, a gaming device 400 may include a game display 402, a user interface panel 406 including one or more physical buttons 408, a wager input device 410, one or more counters 411, and a processor 412. The game display 402 may include a grid of card positions forming one or more poker hands 403. When, as according to embodiments, a predefined criterion is met, one or more designated card positions (randomly designated or selected according to a predefined algorithm) 404 may have an associated virtual card upgraded to a more preferrable virtual card for the poker hand 403. In addition, a bonus feature 405 may be triggered where an award modifier or game modifier may be implemented for a current poker gaming event and/or future poker gaming events. The processor 412 may be operable to perform various processes in connection with the other components of the gaming device 400. In this embodiment, the processor 412 is configured to deal random cards from a deck of virtual playing cards to a poker hand 403 in process 414. In optional process 416, the processor 412 may determine if an award modifier should be applied to the hand. Process 416 may include making a random determination of whether or not to apply an award modifier independent of the cards dealt to the poker hand 403 in process 414, determining whether to apply an award modifier based on the cards dealt to the poker hand in process 414, or identify whether an award modifier had been awarded in a previous poker game or poker gaming event that is to be applied to the current poker hand. In process 418, the processor determines if the dealt cards in the poker hand 403 satisfies a predefined criterion (or upgrade criterion). If the dealt cards in the poker hand 403 does satisfy the predefined criterion, the processor 412 proceeds to process 420 where an upgrade feature in initiated to upgrade the cards in the poker hand 403. This upgrade feature, as discussed herein, can take many different forms in different embodiments. In one example, a random card position 404 is designated to receive an upgrade card that provides the dealt poker hand 403 a better poker hand with which to play.

If the dealt cards in the poker hand 403 does satisfy the predefined criterion in process 418, or after the dealt poker hand has been upgraded in process 420, the processor 412 proceeds to optional process 430 to allow cards to be held and to draw new cards to replace any non-held cards in the poker hand 403. This optional process 430 shown in FIG. 4 is used when the poker game is a draw poker game. However, in different poker embodiments not shown in FIG. 4, process 430 may be used to carry out other portions of various types of poker games. For example, if the poker game was a Texas Hold 'Em style poker game, process 430 may be used to provide the flop cards, turn card, and river card.

In the poker game is a draw poker game, the processor 412 may then proceed to optional process 432 where it is determined if a drawn hand (or final hand) for the poker hand 403 satisfies a predefined upgrade criterion. Similar the processes above, if it is determined that the drawn hand 403 satisfied the predefined upgrade criterion, the processor 412 proceeds to optional process 434 to upgrade the drawn poker hand using upgrade techniques described herein. If the drawn hand hand 403 does not satisfy the predefined upgrade criterion in process 432, or after the drawn hand has been upgraded in process 434 (or if it is not a draw poker game and optional processes 432 and 434 are not implemented), the processor 412 proceeds to process 440, where the current poker hand 403 is evaluated for awards (and if an award modifier was determined in process 416, the award modifier is applied to the current poker hand and/or the determined award).

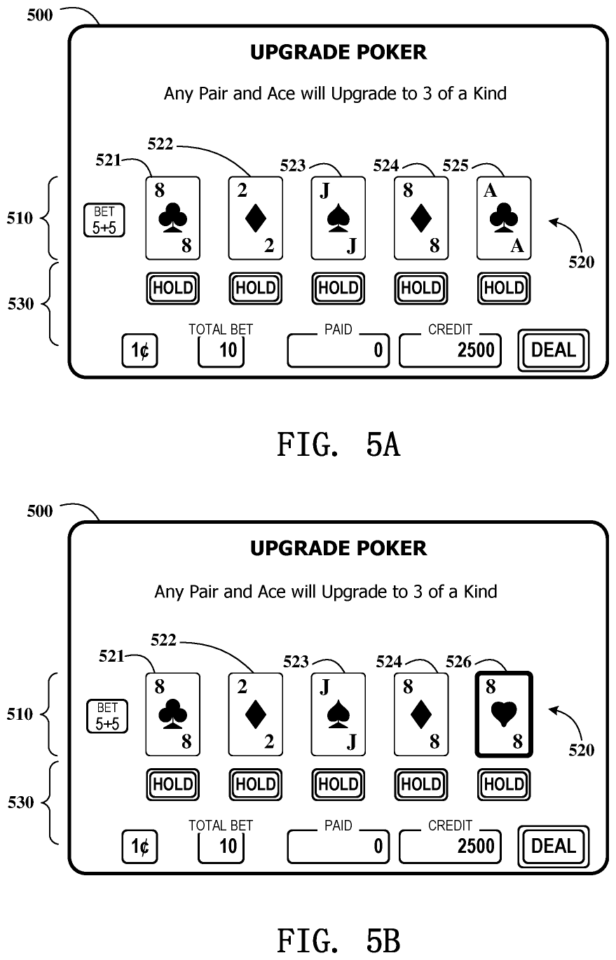

FIGS. 5A and 5B are detail diagrams of a gaming device display showing a game progression according to embodiments of the invention. In this example embodiment, an upgrade criterion is based on whether a pair and a special designated card (in this case, an Ace) is received on the deal, where the special designated card will be replaced with a card of the same rank as the received pair in order to form a 3 of Kind poker hand.

Referring to FIG. 5A, a gaming device display 500 includes a game play area 510 configured to display a grid of card positions 521-525 making up one or more poker hands 520 as part of the poker game, and a player interface area 530 showing various buttons, meters, and/or information to allow the player to interact with the poker game on the gaming device. Here, the gaming device is configured so that the virtual cards shown in the card positions 521, 524, 525 of the poker hand 520 meets a predefined criterion. That is, in this particular embodiment as discussed above, the predefined upgrade criterion is based on whether a pair and an Ace are received on the deal, where a pair of 8s are received in card positions 521 and 524 and a designated card (an Ace) is received in card position 525.

Referring to FIG. 5B, the designated Ace in card position 525 is replaced by another virtual card with a rank of 8 (either an 8 of Hearts or an 8 of Spades) 526, which may be randomly determined or whichever one of the cards is next in a randomly selected sequence of virtual cards. In some embodiments, the designated Ace card in card position 525 that is removed may randomly be placed back into a virtual deck of cards such that it may be received on a draw, while in other embodiments, the designated Ace card may be removed from further play in the poker game (or gaming event). In the embodiment shown in FIG. 5B, an 8 of Hearts replaces the designated Ace card 526 in card position 525 to upgrade the poker hand 520 to a three of a kind. In some embodiments, receiving multiple designated cards (in this case receiving two Ace cards) may result in both designated cards being replaced with 8s leading to a four of a kind of 8s (i.e., quads of 8s). This may also result in a 5 of kind poker hand if, for example, two 8s and three Aces were received on the deal.

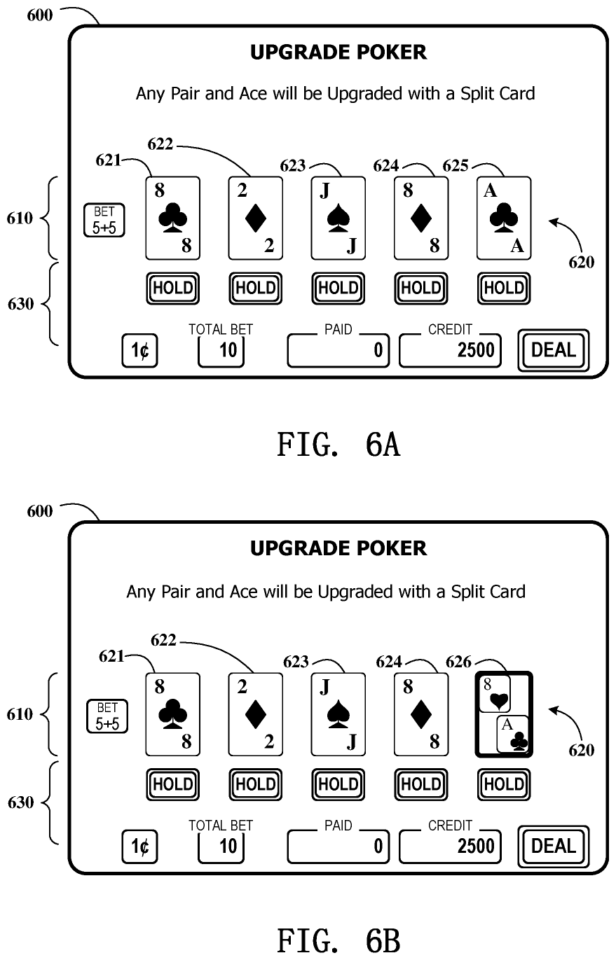

FIGS. 6A and 6B are detail diagrams of a gaming device display showing a game progression according to embodiments of the invention. In this example embodiment, when an upgrade criterion is satisfied, instead of replacing one of the other cards with a card that upgrades the poker hand, the selected card in the dealt poker hand is converted into a multi-indicia card that can be used both as the original card and as the upgraded card.

Referring to FIG. 6A, a gaming device display 600 includes a game play area 610 configured to display a grid of card positions 621-625 making up one or more poker hands 620 as part of the poker game, and a player interface area 630 showing various buttons, meters, and/or information to allow the player to interact with the poker game on the gaming device. Here, the gaming device is configured so that the virtual cards shown in the card positions 621, 624, 625 of the poker hand 620 meets a predefined criterion. That is, in this particular embodiment as discussed above, the predefined upgrade criterion is based on whether a pair and an Ace are received on the deal, where a pair of 8s are received in card positions 621 and 624 and a designated card (an Ace) is received in card position 625. Referring to FIG. 6B, the designated Ace in card position 625 is replaced by a multi-indicia card 626 that includes both the Ace of Clubs and the 8 of Hearts, which can each be used for evaluation purposes. Again, the additional virtual card with a rank of 8 (either an 8 of Hearts or an 8 of Spades) may be randomly determined or may be selected based on whichever one of the cards is next in a randomly selected sequence of virtual cards. The multi-indicia card 626 may give the processor the ability to determine the best five card poker hand out of the six possible cards shown in the poker hand 620.

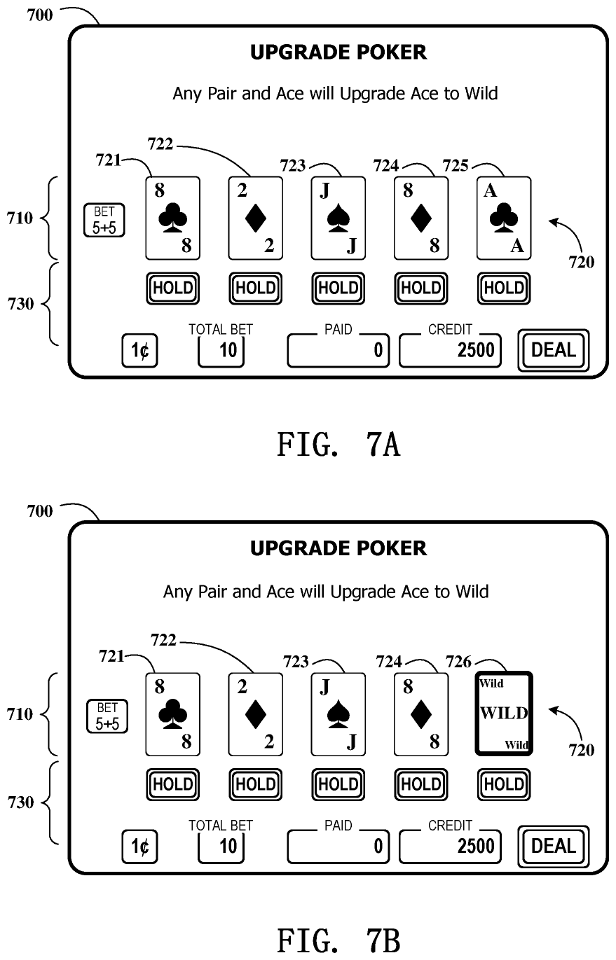

FIGS. 7A and 7B are detail diagrams of a gaming device display showing a game progression according to embodiments of the invention. In this example embodiment, when an upgrade criterion is satisfied, instead of replacing one of the other cards with a card to match a pair or other possible upgrade, the selected card in the dealt poker hand is converted into a wild card that can be used both as any card.

Referring to FIG. 7A, a gaming device display 700 includes a game play area 710 configured to display a grid of card positions 721-725 making up one or more poker hands 720 as part of the poker game, and a player interface area 730 showing various buttons, meters, and/or information to allow the player to interact with the poker game on the gaming device. Here, the gaming device is configured so that the virtual cards shown in the card positions 721, 724, 725 of the poker hand 720 meets a predefined criterion. That is, in this particular embodiment as discussed above, the predefined upgrade criterion is based on whether a pair and an Ace are received on the deal, where a pair of 8s are received in card positions 721 and 724 and a designated card (an Ace) is received in card position 725.

Referring to FIG. 7B, the designated Ace in card position 725 is replaced by a wild card 726, which can then be used any card in the virtual deck to improve the poker hand 720. The Ace of Clubs that is replaced from card position 725 may be randomly reinserted into the virtual deck of cards (where it is available as a potential draw card) or may be removed from the remainder of the poker game.

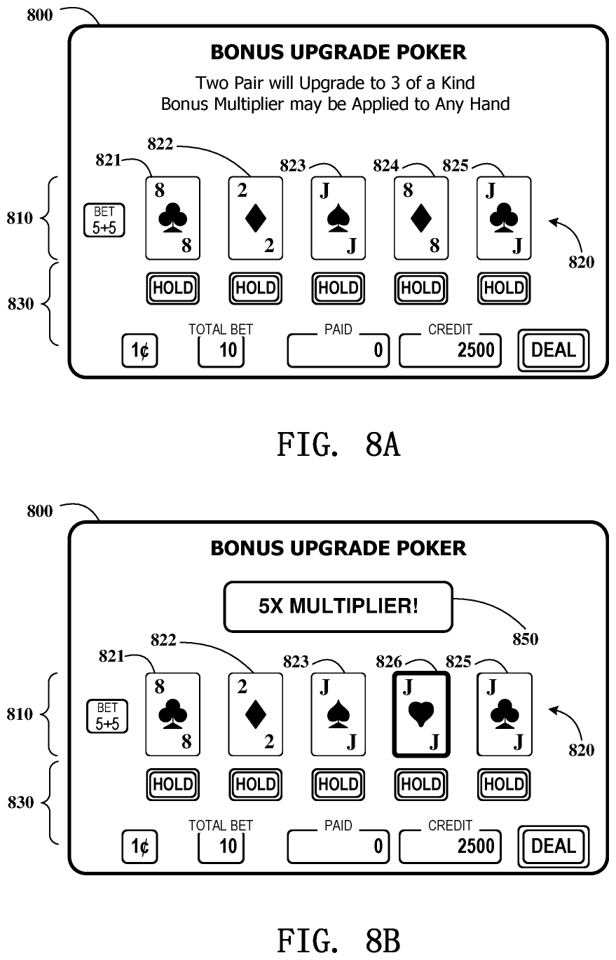

FIGS. 8A and 8B are detail diagrams of a gaming device display showing a game progression according to embodiments of the invention. In this example embodiment, in addition to a hand improvement feature, a random game modifier may also be awarded in the poker game. Here the poker upgrade (hand improvement feature) will upgrade any two pairs to a guaranteed 3 of a kind.

Referring to FIG. 8A, a gaming device display 800 includes a game play area 810 configured to display a grid of card positions 821-825 making up one or more poker hands 820 as part of the poker game, and a player interface area 830 showing various buttons, meters, and/or information to allow the player to interact with the poker game on the gaming device.

Here, the gaming device is configured so that the virtual cards shown in the card positions 821, 823, 824, 825 of the poker hand 820 meets a predefined criterion. That is, in this particular embodiment as discussed above, the predefined upgrade criterion is based on whether two pairs of virtual cards are received on the deal, where a pair of 8s are received in card positions 821 and 824 and a pair of Jacks are received in card positions 823 and 825.

Referring to FIG. 8B, a bonus award modifier is determined and indicated on the gaming device display 800 in a bonus area 850. This bonus award modifier may be randomly determined or may be based the dealt poker hand 820. The amount of the bonus modifier may be determined by a secondary bonus game or may simply be determined and shown in the bonus area 850. In addition, the higher-ranked pair (in this case the pair of Jacks) is maintained in card positions 823 and 825 while a random one of the other cards (in this case the 8 of Diamonds in card position 824) is replaced by another Jack card 826 to give a three of kind. In some embodiments, one of the cards making up the lower pair is randomly replaced (or replaced based on a predetermined rule, such as the card further left or the card with the lower suit value) is replaced with the new card 826, while in other embodiments, any of the other cards may be replaced, which in a third of cases would result in a full house poker hand.

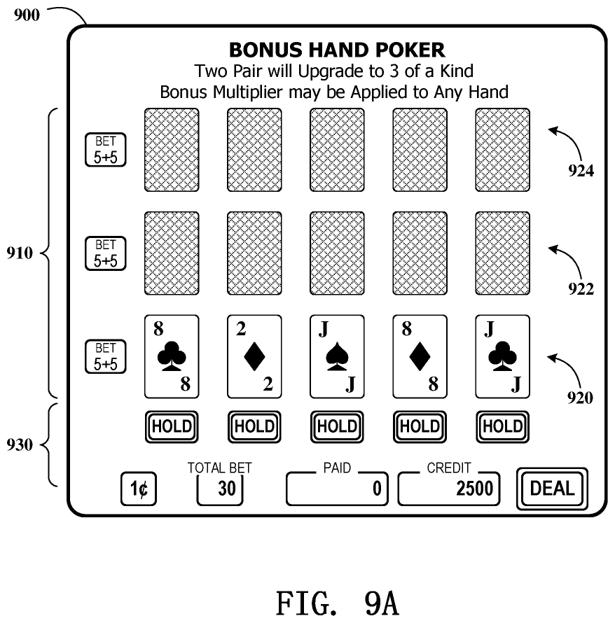

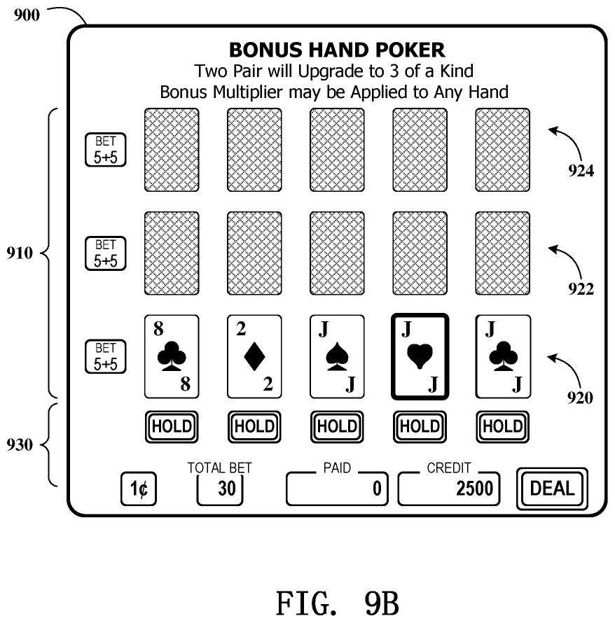

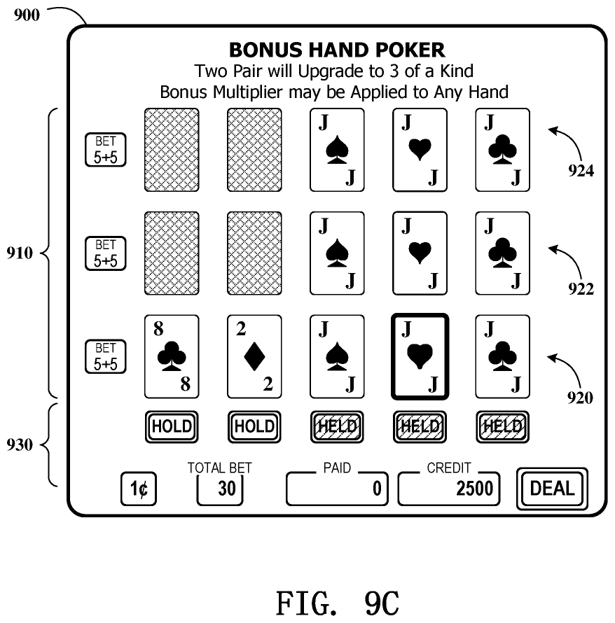

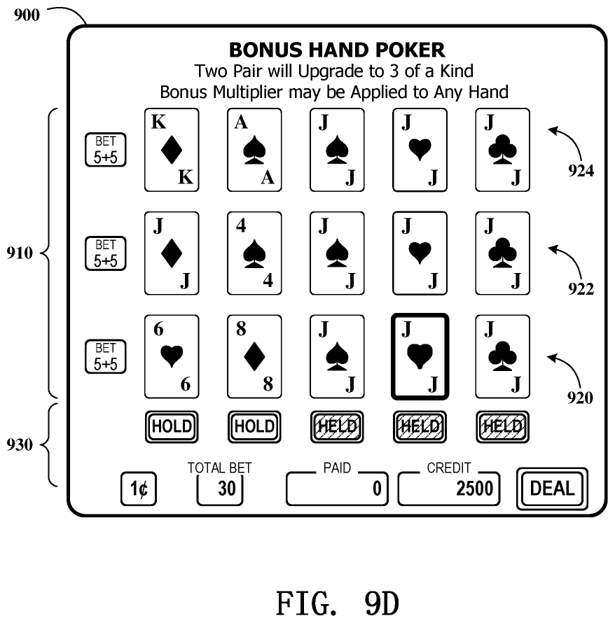

FIGS. 9A, 9B, 9C, and 9D are detail diagrams of a gaming device display showing a game progression according to embodiments of the invention. In this example embodiment, a multi-hand poker embodiment using a hand improvement feature is shown. Here, the hand improvement feature is used to upgrade the dealt poker hand prior to the cards being held and replicated into the second poker hand and third poker hand.

Referring to FIG. 9A, a gaming device display 900 includes a game play area 910 configured to display a grid of card positions making up a first poker hand 920, a second poker hand 922 and a third poker hand 924 as part of the poker game, and a player interface area 930 showing various buttons, meters, and/or information to allow the player to interact with the poker game on the gaming device. Here, the gaming device is configured so that the virtual cards of the first poker hand 920 must meet a predefined criterion. In this particular embodiment, the predefined criterion is based on whether two pairs are received in the dealt poker hand 920. In addition, the poker game includes a bonus feature where a bonus multiplier will be applied to any awards won if the predefined criterion is satisfied.

Referring to FIG. 9B, one of the cards in the lower pair of the dealt poker hand is replaced by a card that matches the rank of the cards in the higher pair. That is, one of the pair of 8s is replaced by another Jack to form a three of a kind. Referring to FIG. 9C, the player holds the three Jack cards in the dealt poker hand 620. These held cards are then copied into the second poker hand 922 and third poker hand 924 as shown in FIG. 9C. Referring to FIG. 9D, after the player hits the Draw button, the non-held cards in the first poker hand 920 are replaced with new virtual playing cards and the remaining card positions in the second poker hand 922 and 924 are filled with random virtual cards. In some embodiments, separate decks of cards are used for each of the first, second and third poker hands 920, 922, 924. Each of these final poker hands in then evaluated for awards and that first poker game (or first gaming event) is over.

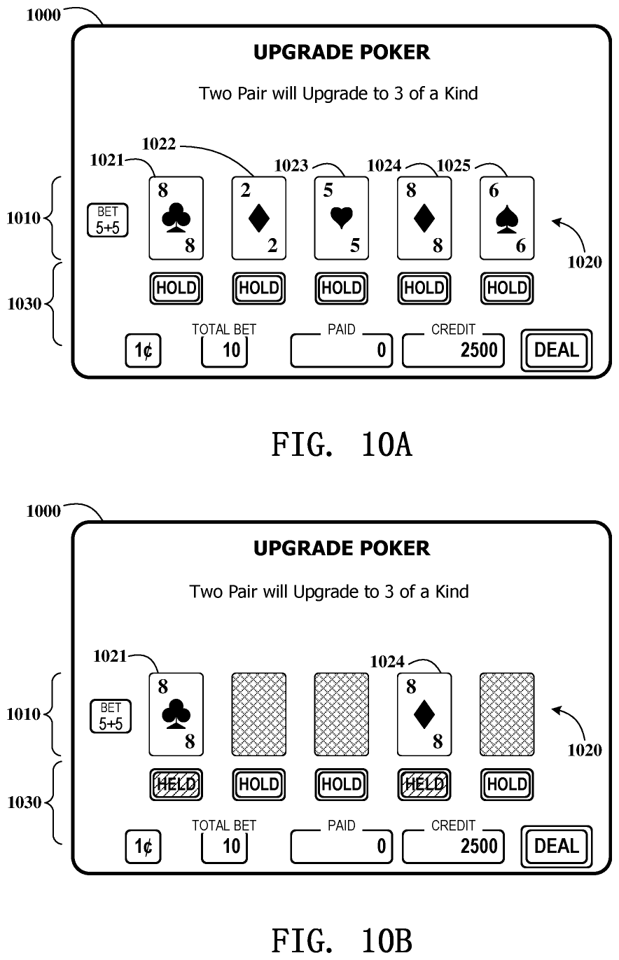

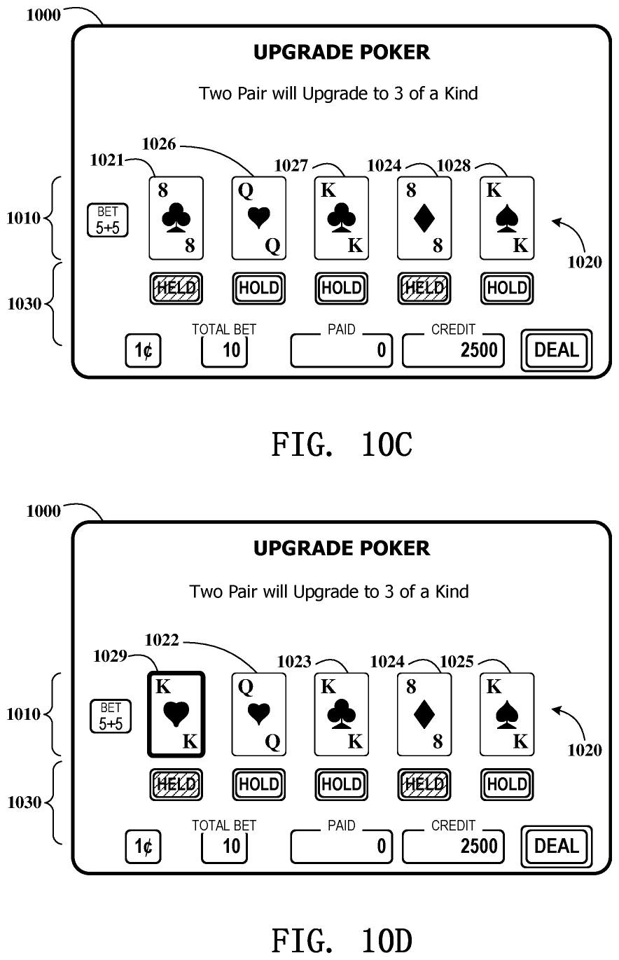

FIGS. 10A, 10B, 10C, and 10D are detail diagrams of a gaming device display showing a game progression according to embodiments of the invention. In this example embodiment, the hand improvement feature is satisfied on the final poker hand after the player has had an opportunity to hold cards and draw new cards. Thus, although the dealt poker hand was not upgraded, the final poker hand is upgraded to receive a better award.

Referring to FIG. 10A, a gaming device display 1000 includes a game play area 1010 configured to display a grid of card positions 1021-1025 making up one or more poker hands 1020 as part of the poker game, and a player interface area 1030 showing various buttons, meters, and/or information to allow the player to interact with the poker game on the gaming device. Here, the dealt poker hand in 1020 does not satisfy the predefined upgrade criterion, and hence the poker game plays as a normal draw poker game where the play is allowed to hold cards and draw new cards. Here, as shown in FIG. 10B, the player holds the pair of dealt 8s in cards positions 1021 and 1024.

Referring to FIG. 10C, replacement cards are dealt to card positions 1022, 1023, and 1025 with replacement cards 1026, 1027 and 1028. Here, the draw poker hand now satisfies the predefined upgrade criterion as two pairs are now part of the drawn poker hand. Referring to FIG. 10D, a random one of the lower pair cards is replaced with another card 1029 of the same rank as the higher rank pair. Hence, the player ends up with a 3 of kind hand instead of two pairs in the final poker hand.

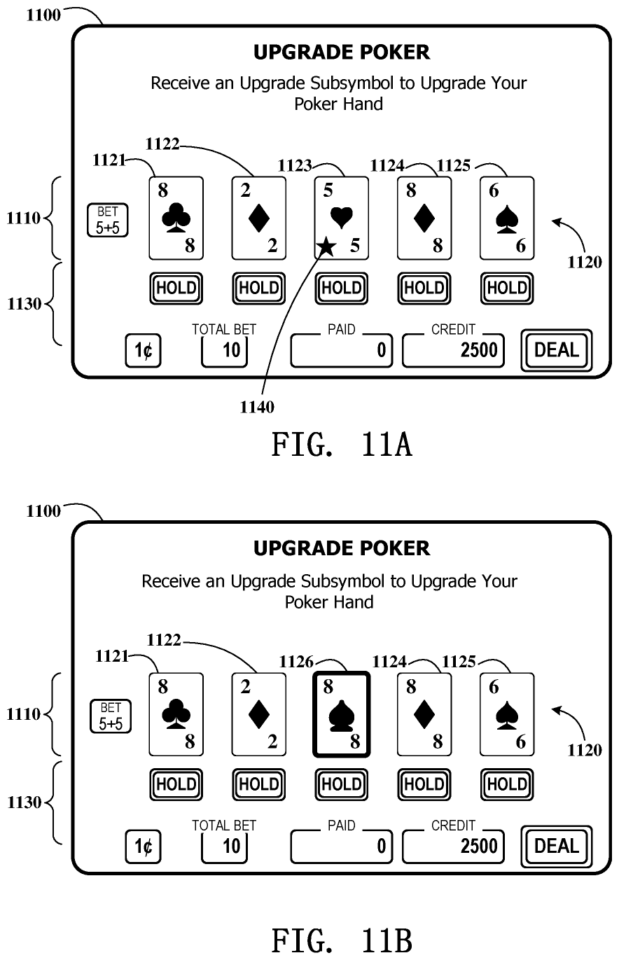

FIGS. 11A and 11B are detail diagrams of a gaming device display showing a game progression according to embodiments of the invention. In this example embodiment, the upgrade criterion is satisfied with an upgrade subsymbol is received on one of the dealt cards. In some embodiments, only the card that is associated with the upgrade subsymbol can be replaced and upgraded, while in other embodiments if any of the dealt cards is associated with an upgrade subsymbol, any of the cards in the poker hand can be replaced to upgrade the overall poker hand.

Referring to FIG. 11A, a gaming device display 1100 includes a game play area 1110 configured to display a grid of card positions 1121-1125 making up one or more poker hands 1120 as part of the poker game, and a player interface area 1130 showing various buttons, meters, and/or information to allow the player to interact with the poker game on the gaming device. Here, the gaming device is configured so that the virtual cards shown in the card positions 1121, 1123, 1124 of the poker hand 1120 meets a predefined criterion. That is, in this particular embodiment as discussed above, the predefined upgrade criterion is based on whether a pair and an upgrade subsymbol 1140 are received on the deal, where a pair of 8s are received in card positions 1121 and 1124 and an upgrade subsymbol is received in card position 1123.

Referring to FIG. 11B, the virtual card (5 of Hearts) associated with the upgrade subsymbol 1140 in card position 1123 is replaced by another virtual card with a rank of 8 (either an 8 of Hearts or an 8 of Spades) 1126, which may be randomly determined or whichever one of the cards is next in a randomly selected sequence of virtual cards. In some embodiments, the virtual card that is associated with the upgrade subsymbol in card position 1123 that is removed may randomly be placed back into a virtual deck of cards such that it may be received on a draw, while in other embodiments, the replaced card may be removed from further play in the poker game (or gaming event).

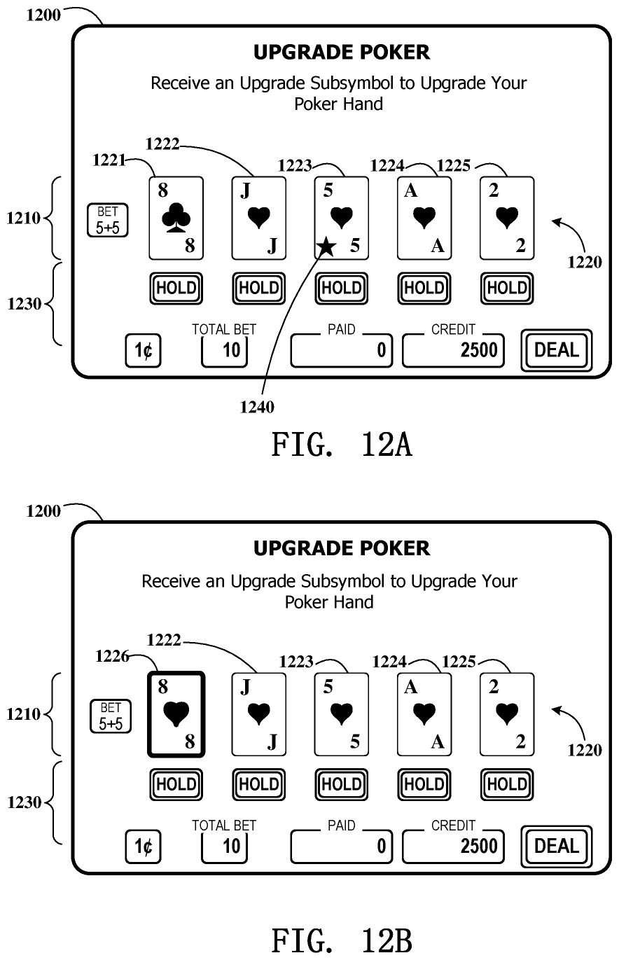

FIGS. 12A and 12B are detail diagrams of a gaming device display showing a game progression according to embodiments of the invention. In this example embodiment, a hand may be improved by upgrading a card when an upgrade subsymbol is received, and the upgrade will be made with optimum strategy to give the best return on the poker hand. Referring to FIG. 12A, a gaming device display 1200 includes a game play area 1210 configured to display a grid of card positions 1221-1225 making up one or more poker hands 1220 as part of the poker game, and a player interface area 1230 showing various buttons, meters, and/or information to allow the player to interact with the poker game on the gaming device. Here, the gaming device is configured so that the virtual card shown in the card position 1223 of the poker hand 1220 meets a predefined criterion. That is, in this particular embodiment as discussed above, the predefined upgrade criterion is based on whether an upgrade subsymbol 1240 is received on the deal, where an upgrade subsymbol is received in card position 1223.

Referring to FIG. 12B, any one (or two or more in some embodiments) of the virtual cards in the poker hand 1220 that can be upgraded to give the player the best possible dealt poker are replaced by cards that give the player the best dealt poker hand. In this case, four heart cards were part of the dealt poker hand 1220, so the best dealt poker hand upgrade for replacing one of the dealt cards is to replace the 8 of Clubs with an 8 of Hearts to give the player a flush poker hand.

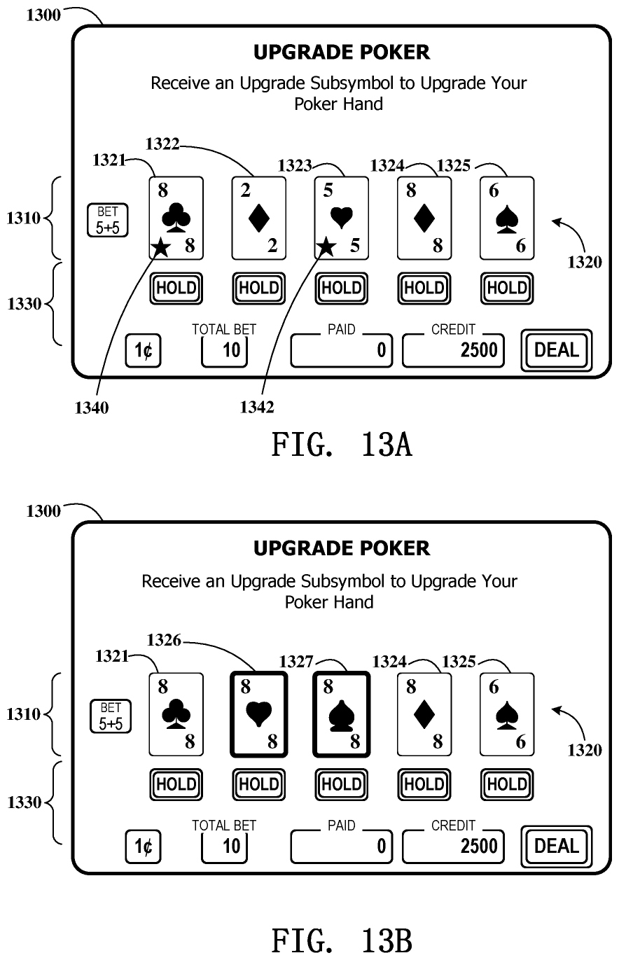

FIGS. 13A and 13B are detail diagrams of a gaming device display showing a game progression according to embodiments of the invention. In this example embodiment, multiple upgrade subsymbols are received meaning that multiple ones of the cards in the poker hand can be upgraded.

Referring to FIG. 13A, a gaming device display 1300 includes a game play area 1310 configured to display a grid of card positions 1321-1325 making up one or more poker hands 1320 as part of the poker game, and a player interface area 1330 showing various buttons, meters, and/or information to allow the player to interact with the poker game on the gaming device. Here, the gaming device is configured so that the virtual cards shown in the card positions 1321 and 1323 of the poker hand 1320 meet a predefined criterion. That is, in this particular embodiment as discussed above, the predefined upgrade criterion is based on whether one or more upgrade subsymbol 1340, 1342 is received on the deal, where upgrade subsymbols are received in card positions 1321 and 1323.

Referring to FIG. 13B, the two the virtual cards in the poker hand 1320 that can be upgraded to give the player the best possible dealt poker are replaced by cards that give the player the best dealt poker hand. In this case, since a pair of 8s were part of the dealt poker hand 1320, two other cards 1326 and 1327 are replaced with additional virtual cards with a rank of 8s resulting in a four of a kind.

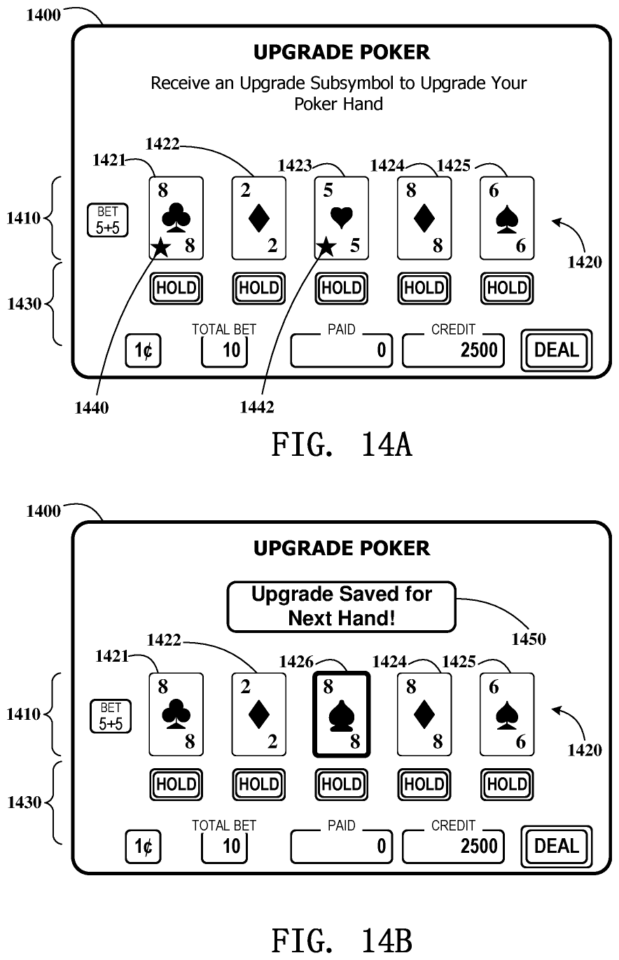

FIGS. 14A and 14B are detail diagrams of a gaming device display showing a game progression according to embodiments of the invention. In this example embodiment, multiple upgraded subsymbols are again received, but only one can be used on a current hand. Hence, the other received upgrades are saved and will be used on the next poker hand(s).

Referring to FIG. 14A, a gaming device display 1400 includes a game play area 1410 configured to display a grid of card positions 1421-1425 making up one or more poker hands 1420 as part of the poker game, and a player interface area 1430 showing various buttons, meters, and/or information to allow the player to interact with the poker game on the gaming device. Here, the gaming device is configured so that the virtual cards shown in the card positions 1421 and 1423 of the poker hand 1420 meet a predefined criterion. That is, in this particular embodiment as discussed above, the predefined upgrade criterion is based on whether one or more upgrade subsymbol 1440, 4342 is received on the deal, where upgrade subsymbols are received in card positions 1421 and 1423.

Referring to FIG. 14B, one of the virtual cards in the poker hand 1420 that can be upgraded to give the player the best possible dealt poker is replaced by cards that give the player the best dealt poker hand. In this case, one of the non-pair of cards in poker hand 1420, one other card 1426 is replaced with an additional virtual card with a rank of 8 resulting in a three of a kind and one of the upgrades is saved for a future hand as indicated in the award message area 1450.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games). Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings.

Rather, the invention is intended to cover alternatives, modifications, and equivalents that come within the scope and spirit of the inventive principles set out herein.

1. A gaming device comprising:
a display including a video screen having a poker game play grid having a plurality of card positions;
a player interface including at least one button, the button configured to generate a signal in response to being activated;
a memory configured to store a deck of virtual cards and a credit amount;
a wager input device structured to receive physical items associated with currency values; and
a processor operable to:
receive a signal indicating receipt of a physical item associated with a currency value;
increase the credit amount stored in the memory based on the currency value associated with the received physical item;
receive a game initiation signal including a wager amount to initiate a poker gaming event, the wager amount deducted from the credit amount stored in the memory;
randomly determine a sequence of virtual playing cards to use in the poker gaming event from the deck of virtual playing cards stored in the memory of the gaming device;
determine, starting at a first virtual card of the randomly determined sequence:
(a) whether an examined virtual playing card meets a predefined condition,
(b) displaying the examined virtual playing card in a first card position of the game play grid if the virtual playing card satisfies the predefined condition,
(c) examining a next card in the randomly determined sequence if the virtual player card does not satisfy the predefined condition, and
(d) repeating steps (a)-(c) until the virtual playing card satisfies the predefined condition;
deal virtual cards from the randomly determined sequence to the remaining card positions in the plurality of card positions in the poker game play grid to complete a dealt poker hand;
receive signals to hold cards in the dealt poker hand;
replace any non-held cards in the dealt poker hand with replacement cards from the randomly determined sequence to complete a final poker hand;
evaluate the final poker hand for awards; and
increase the credit amount stored in the memory based on any awards determined from the evaluation of the final poker hand.
